(19) United States
(12) Patent Application Publication
(10) Pub. No.: US 2009/0011305 A1
(43) Pub. Date: Jan. 8, 2009

(54) Fuel cell system and membrane electrode assembly thereof

(75) Inventors: Ching-Po Lee, Hsinchu (TW); Cheng Wang, Hsinchu (TW); Jin-Shu Huang, Hsinchu (TW); Nien-Hui Hsu, Hsinchu (TW)

Correspondence Address: BACON & THOMAS, PLLC, 625 SLATERS LANE, FOURTH FLOOR, ALEXANDRIA, VA, 22314-1176, US

(73) Assignee: Coretronic Corporation, Hsinchu (TW)

(21) Appl. No.: 11/905,435

(22) Filed: Oct. 1, 2007

(30) Foreign Application Priority Data
Mar. 30, 2007 (TW) 096111373

(51) Int. Cl. H01M 8/02; H01M 8/10

(52) U.S. Cl. 429/27; 429/30; 429/34

(57) ABSTRACT

A membrane electrode assembly (MEA) of a three-edge configuration is provided for a fuel cell system. The MEA is tailored to have three edges and the three edges are embedded in an open space of a frame. The three-edge MEA is arranged between an anode collector plate and a cathode collector plate of the fuel cell system. A flow field plate is arranged at the anode side of the MEA with the anode collector plate interposed between the flow field plate and the MEA. The flow field plate forms a fuel transporting channel that is delimited by three side walls and has three vertices. The configuration of the fuel transporting channel corresponds in shape to the three-edge configuration of the MEA and is in communication with at least one fuel inlet and at least one fuel outlet corresponding to the fuel inlet. Anode fuel is fed through the fuel inlet into the fuel transporting channel of the flow field plate and then discharged through the fuel outlet whereby the anode fuel carries out catalytic reaction with the MEA.

### FIELD OF THE INVENTION

The present invention relates to a fuel cell, and in particular to a fuel cell system comprising a membrane electrode assembly that is tailored to form a three-edge configuration, to which an anode collector plate, a cathode collector plate and a flow field plate of substantially corresponding configuration are coupled to form the fuel cell system.

### BACKGROUND OF THE INVENTION

Fuel cell systems are electrical power generation device that directly uses air and fuel including hydrogen to carry out chemical reaction for generation of electrical power. The fuel cell systems have advantages of low pollution, low noise, and high efficiency, and thus satisfy the current trend of environment protection. A variety of fuel cell systems are available, among which proton exchange membrane fuel cell (PEMFC) and direct methanol fuel cell (DMFC) are the two most commonly known fuel cells.

Referring to FIGS. 1 and 2 of the attached drawings, a conventional fuel cell system, generally designated with reference numeral 100, is shown. The conventional fuel cell 100 comprises a cathode collector plate 101, a membrane electrode assembly (MEA) 102, an anode collector plate 103, and an anode side flow field plate 104. The membrane electrode assembly 102 comprises a proton exchange membrane (PEM), an anode catalyst layer, a cathode catalyst layer, an anode gas diffusion layer (GDL), and a cathode gas diffusion layer. The anode side flow field plate 104 is made of graphite and is arranged at the anode side of the membrane electrode assembly 102 with anode collector plate 103 interposed between the membrane electrode assembly 102 and the anode side flow field plate 104.

The anode collector plate 104 forms a pair of fuel inlets 105 and a pair of fuel outlets 106, which are both in fluid communication with a fuel transporting channel 107 defined in the anode side flow field plate 104. The direct methanol fuel cell usually uses aqueous solution of methanol as fuel for anode. The methanol solution is pumped into the fuel transporting channel 107 through the fuel inlets 105 so that the methanol solution may carry out reaction with the anode catalyst of the membrane electrode assembly. In order to carry out uniform reaction between the methanol and the anode catalyst, the geometry of the fuel transporting channel of the anode side flow field plate and the relative positions of the fuel inlets and the fuel outlets are of vital importance.

As to the configuration of the membrane electrode assembly, conventionally, the membrane electrode assembly adopted in the conventional fuel cell systems is of a rectangular configuration as shown in FIG. 3, which is a top plan view of a conventional membrane electrode assembly of the fuel cell systems. The rectangular configuration is taken simply for better utilization of the proton exchange membrane after being tailored, so as to reduce the waste of material. In addition, the arrangement of a plurality of rectangular membrane electrode assemblies together can be made compact and small-sized, reducing the overall size of the whole unit of the combination of the plurality of membrane electrode assemblies.

Although the currently adopted rectangular membrane electrode assembly has better utilization of the proton exchange membrane, can reduce the waste of material, and can be made compact, yet the rectangular membrane electrode assembly inevitably contains dead zones in the flow field of the fuel flowing through the fuel transporting channel thereof, and is difficult to provide uniform flow field. FIG. 4 of the attached drawings demonstrates, in a schematic form, the flow field of the fuel flowing through the fuel transporting channel of the anode side flow field plate of the conventional membrane electrode assembly of the fuel cell. The anode fuel flows, generally designated at FI1, FI2, are fed through the fuel inlets 105 respectively and are distributed over and travels through the fuel transporting channel 107 of the anode side flow field plate 104. The fuel, after traveling through the fuel transporting channel 107, is drained through the fuel outlets 106. In the conventional structure, when the anode fuel flows into the fuel transporting channel 107 of the anode side flow field plate 104, the flow is subject to limitation imposed by the geometry of the fuel transporting channel 107, as well as the spatial arrangement of the fuel inlets 105 and the fuel outlets 106 with respect to the fuel transporting channel 107, whereby low speed zones 108, 109 are formed in the fuel transporting channel 107, which indicate dead zones of the flow field. Thus, the fuel transporting channel 107 of the conventional flow field plate suffers non-uniform speed distribution of the flow field of the anode fuel within the fuel transporting channel 107.

It is known that a well-designed fuel transporting channel of a flow field plate must induce substantially uniform flow speed at different zones of the flow field within the fuel transporting channel with substantially reduced low speed zones, in order to ensure uniformity of reaction over the whole membrane electrode assembly. The conventional designs, however, cannot satisfy such a requirement.

In order to make the flow field inside the rectangular membrane electrode assembly uniform, a currently adopted solution is to increase the number of the fuel inlets and the fuel outlets. This, however, complicates the whole structure of the fuel transporting channel.

Thus, it is desired to have a fuel cell that overcomes the above drawbacks of the conventional fuel cells.

### SUMMARY OF THE INVENTION

Thus, an objective of the present invention is to provide a fuel cell system the configuration of which is not limited to the conventional rectangular configuration so as to provide flexibility of applications for the fuel cell system.

Another objective of the present invention is to provide a fuel cell having a three-edge configuration and comprising a membrane electrode assembly, an anode collector plate, a cathode collector plate, and a flow field plate all having a three-edge configuration, which, together with proper arrangement of fuel inlet(s) and fuel outlet(s), effectively reduces dead zones within the flow field of fuel flowing through the flow field plate.

A further objective of the present invention is to provide a fuel cell system featuring uniform flow of fuel, compared with the conventional fuel cell system. The fuel cell system comprises a flow field plate having a three-edge configuration, which, without any flow guide or flow equalization element, provides an excellent flow field for the conveyance of anode fuel through the fuel cell system, making the anode fuel uniformly distributed over the fuel conveyance fuel transporting channel defined in the flow field plate.

To achieve the objectives mentioned above, in accordance with an embodiment of the present invention, a membrane electrode assembly (MEA) is provided for a fuel cell system. The MEA is tailored to have a three-edge configuration and the three edges are embedded in an open space of a frame. The three-edge MEA is arranged between an anode collector plate and a cathode collector plate of the fuel cell system. A flow field plate is arranged at the anode side of the MEA with the anode collector plate interposed between the flow field plate and the MEA. The flow field plate forms a fuel transporting channel that is delimited by three side walls and has three vertices. The configuration of the fuel transporting channel corresponds in shape to the three-edge configuration of the MEA and is in communication with at least one fuel inlet and at least one fuel outlet corresponding to the fuel inlet.

In accordance with another embodiment of the present invention, the MEA comprises first and second MEA zones, which are combined together in a coplanar and juxtaposing manner. The MEA has an anode side and a cathode side. The MEA is combined with a fuel transporting channel having first and second fuel transporting channels corresponding thereto to form a fuel cell set.

As compared with the rectangular MEA that is employed in the conventional fuel cell, the present invention provides a more uniform flow field of fuel. The MEA, the anode collector plate, the cathode collector plate, and the flow field plate of the present invention are all in a three-edge configuration, which, together with the arrangement of fuel inlet and fuel outlet, effectively reduces dead zones of the flow field and also reduces flow resistance.

The present invention uses a simple triangular MEA and flow field plate to provide an excellent flow field for conveyance of fuel in the anode plate and thus making anode fuel uniformly distributed over the fuel conveyance fuel transporting channel of the flow field plate.

The present invention not only features uniform flow field, compared with the conventional fuel cell, but also maintains the utilization rate of the proton exchange membrane of the MEA.

In accordance with the present invention, a plurality of paired flow field plates can be incorporated with paired MEA zones to form a combined flow field plate module, which helps for modularized applications. In the piping arrangement, all the fuel inlets of the flow field plates can be set in communication with a single fuel supply line, and all the fuel outlets can be disposed in communication with a single fuel drain line so that the piping arrangement for fuel inlet and fuel outlet can be simplified.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The present invention will be apparent to those skilled in the art by reading the following description of preferred embodiments thereof, with reference to the attached drawings, in which:

FIG. 1 is an exploded view of a conventional direct methanol fuel cell;

FIG. 2 is a cross-sectional view of the conventional direct methanol fuel cell in an assembled form;

FIG. 3 is a top plan view of a conventional membrane electrode assembly of a fuel cell system;

FIG. 4 schematically illustrates flow field generated inside an anode side flow field plate that constitutes a membrane electrode assembly of the conventional fuel cell system shown in FIG. 1;

FIG. 5 is an exploded view of a fuel cell system constructed in accordance with a first embodiment of the present invention;

FIG. 6 is a cross-sectional view taken along line 6-6 of the membrane electrode assembly of the fuel cell system shown in FIG. 5;

FIG. 7 schematically illustrates flow field generated inside a flow field plate of the fuel cell system shown in FIG. 5;

FIG. 8 illustrates a second example of the flow field plate of FIG. 5, wherein the fuel transporting channel is respectively provided with a cut vertex at a fuel inlet and at a fuel outlet;

FIG. 9 illustrates a third example of the flow field plate of FIG. 5, wherein the flow field plate is provided with a single fuel inlet and two fuel outlets;

FIG. 10 is an exploded view of a fuel cell system constructed in accordance with a second embodiment of the present invention;

FIG. 11 is a perspective view of the fuel cell system of the second embodiment of the present invention;

FIG. 12 schematically illustrates flow field generated inside a flow field plate of the fuel cell system shown in FIG. 10;

FIG. 13 is a schematic plan view illustrating a combined membrane electrode assembly constructed in accordance with a third embodiment of the present invention;

FIG. 14 is a schematic plan view illustrating a combined flow field plate that is incorporated with the combined membrane electrode assembly in accordance with the third embodiment shown in FIG. 13; and

FIG. 15 is a plan view illustrating a fourth example of a flow field plate wherein the fuel transporting channel has a trapezoid configuration.

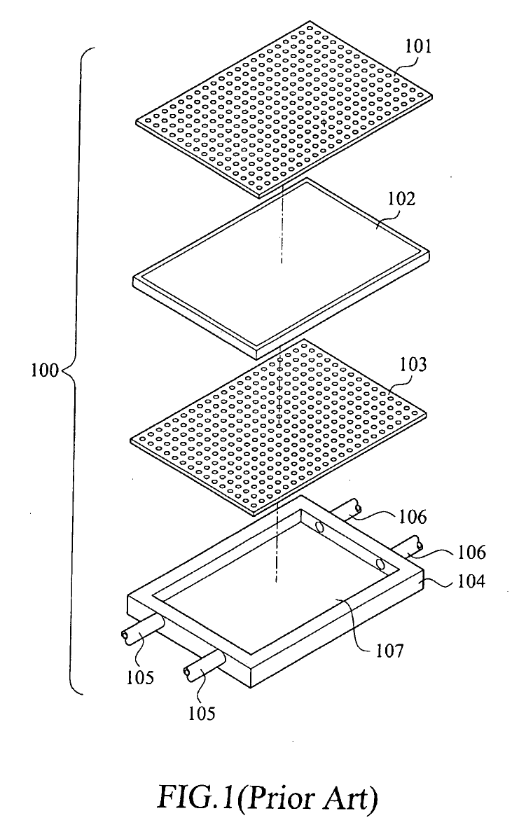

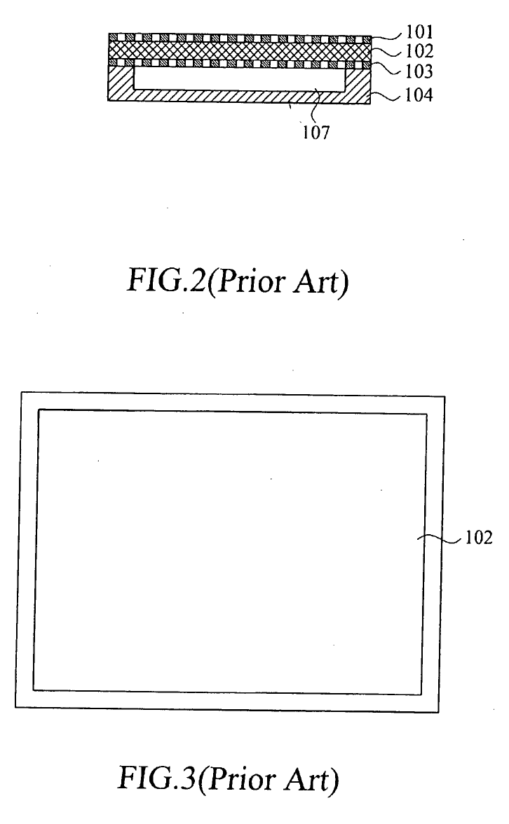

### DETAILED DESCRIPTION OF THE PREFERRED EMBODIMENTS

It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” and “coupled,” and variations thereof herein are used broadly and encompass direct and indirect connections, couplings, and mountings.

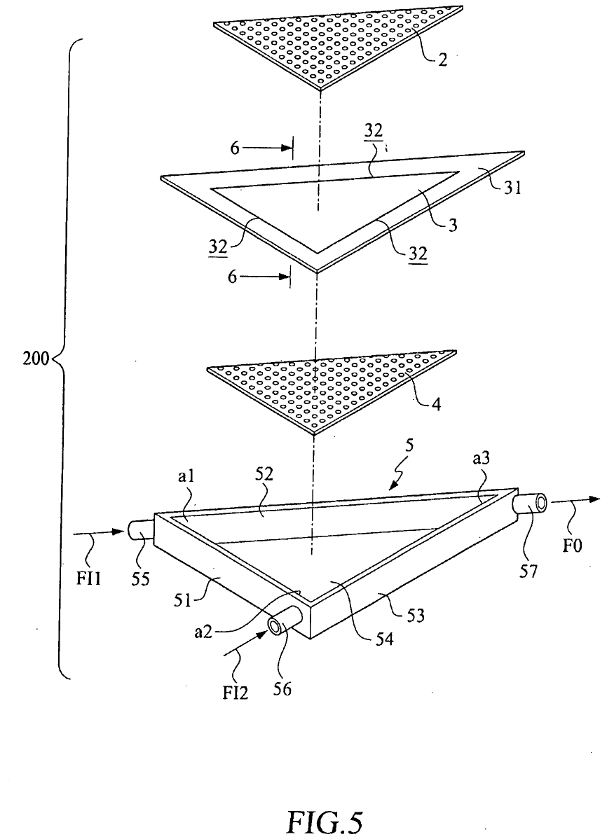

With reference to the drawings and in particular to FIG. 5, a fuel cell constructed in accordance with a first embodiment of the present invention, generally designated with reference numeral 200, is shown. The fuel cell 200 comprises a cathode collector plate 2, a membrane electrode assembly (MEA) 3, an anode collector plate 4, and a flow field plate 5. The membrane electrode assembly 3 has a cathode side and an anode side. The cathode side of the membrane electrode assembly 3 is coupled to the cathode collector plate 2, and the anode side of the membrane electrode assembly 3 is coupled to the anode collector plate 4. The flow field plate 5 is arranged at the anode side of the membrane electrode assembly 3 in such a way that the anode collector plate 4 is interposed between the membrane electrode assembly 3 and the flow field plate 5.

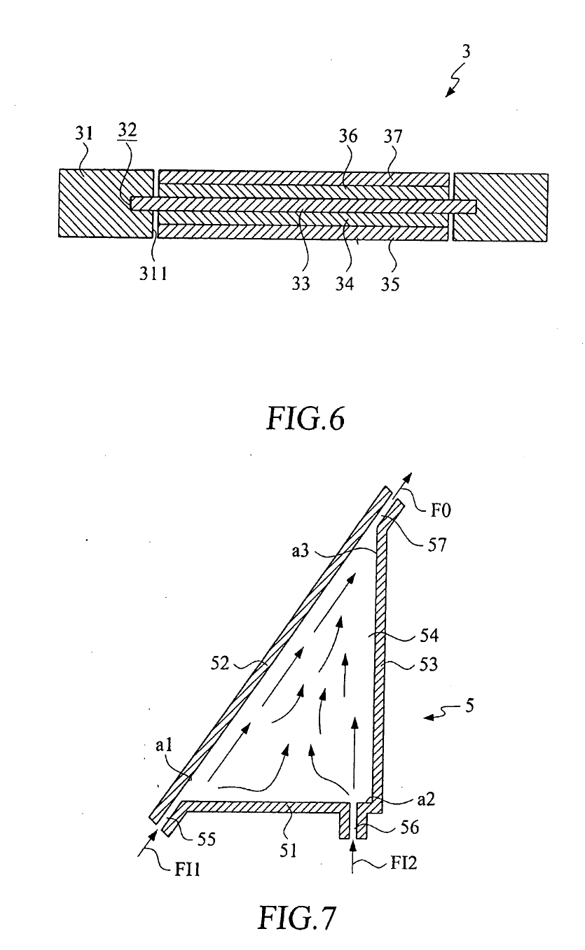

Also referring to FIG. 6, which illustrates a cross-sectional view taken along line 6-6 of the membrane electrode assembly 3 shown in FIG. 5, the membrane electrode assembly 3 is tailored to have a circumference 32 of a triangular configuration, namely having three side edges, and the circumference 32 is embedded in an open space 311 of a frame 31. The membrane electrode assembly 3 comprises a proton exchange membrane 33, which has an anode side and a cathode side. The surface of the anode side of the proton exchange membrane 33 is coated with an anode catalyst layer 34 and an anode gas diffusion layer 35, and the surface of the cathode side of the proton exchange membrane 33 is coated with a cathode catalyst layer 36 and a cathode gas diffusion layer 37.

The cathode collector plate 2, which is coupled to the cathode side of the membrane electrode assembly 3, has a triangular configuration corresponding to the membrane electrode assembly 3. The anode collector plate 4, which is coupled to the anode side of the membrane electrode assembly 3, has a triangular configuration corresponding to the membrane electrode assembly 3.

The flow field plate 5 forms a triangular fuel transporting channel 54 that is delimited by three walls 51, 52, 53 and has three vertices a1, a2, a3. The fuel transporting channel 54 is shaped to correspond to the contour of the membrane electrode assembly 3. The flow field plate 5 forms, at locations close to two vertices a1, a2 thereof, two fuel inlets 55, 56 respectively. The flow field plate 5 also forms a fuel outlet 57 at a location close to the remaining vertex a3 thereof. The fuel inlets 55, 56 and the fuel outlet 57 may be extended in a direction that is substantially normal to the walls of the flow field plate 5 that are opposite to the fuel inlets 55, 56 and the fuel outlet 57, respectively, or at any desired inclination with respect to the respective opposite walls.

Also referring to FIG. 7, which demonstrates, in a schematic form, a flow field generated in the flow field plate 5 illustrated in FIG. 5, anode fuel flows FI1, FI2 are fed, respectively, through the fuel inlets 55, 56 of the flow field plate 5, into the fuel transporting channel 54 of the flow field plate 5 to allow the anode fuel to carry out catalytic reaction with the membrane electrode assembly 3. The fuel, after traveling through the fuel transporting channel 54, is discharged as fuel flow FO through the fuel outlet 57.

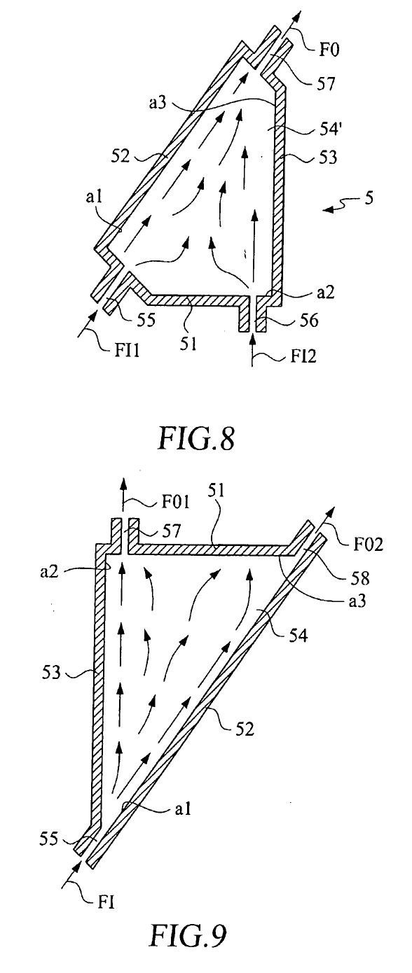

The fuel transporting channel 54 illustrated in FIG. 7 is in a form of triangular construction with three taped vertexes. It is possible to modify the fuel transporting channel 54 to practitioners skilled in this art to cut at least one of the taped vertexes of the fuel transporting channel. For example, FIG. 8 shows that a modified fuel transporting channel 54′ with a cut vertex a1′ communicated with the fuel inlets 55 and a cut vertex a2′ communicated with the fuel outlet 57. It is to be understood that a corresponding configuration of a membrane electrode assembly is used to correspond in shape to the configuration of the fuel transporting channel 54′.

In the construction illustrated in FIG. 5, the flow field plate 5 is provided with two fuel inlets 55, 56 and one fuel outlet 57. As a third example thereto, as shown in FIG. 9, the flow field plate 5 is provided with a single fuel inlet 55 and two fuel outlets 57, 58, wherein an anode fuel flow FI is fed, through the fuel inlet 55, into the fuel transporting channel 54 and then discharged through the fuel outlets 57, 58 as discharged fuel flows FO1, FO2 so that the anode fuel is allowed to carry out catalytic reaction with the membrane electrode assembly 3.

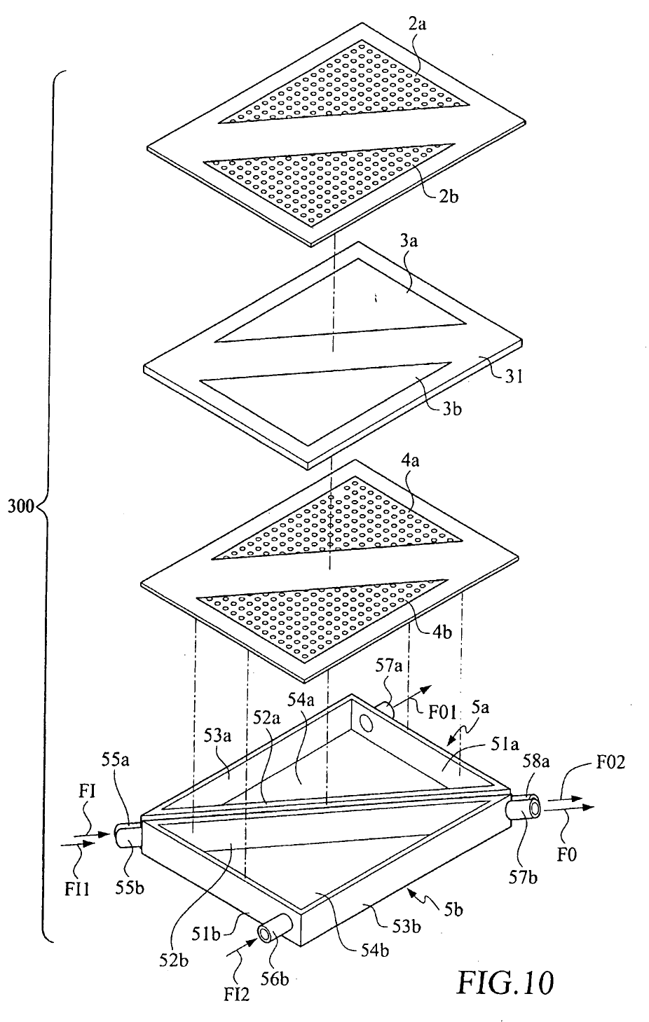

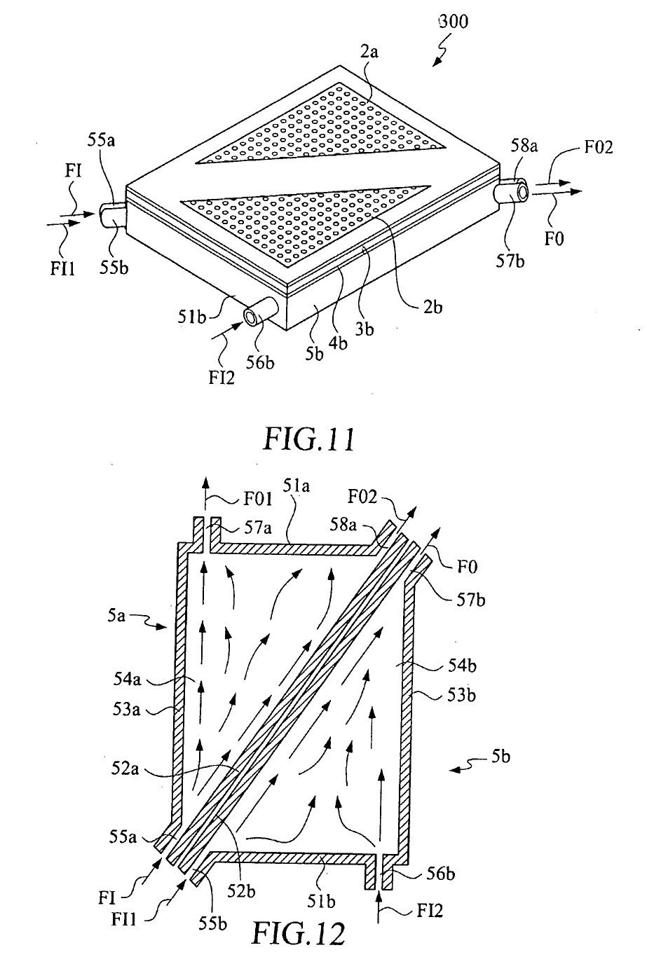

Referring now to FIGS. 10 to 12, which illustrate a fuel cell system constructed in accordance with a second embodiment of the present invention, generally designated at 300. The fuel cell system 300, similarly, comprises a cathode collector plate, a membrane electrode assembly, an anode collector plate, and a flow field plate. The fuel cell system 300 is a combination of two fuel cells 200 that are the first embodiment of the present invention discussed previously with reference to FIG. 5.

In other words, in the second embodiment, the cathode collector plate is formed of a first cathode collector plate 2a and a second cathode collector plate 2b that are fixed together in a coplanar and juxtaposing manner. The membrane electrode assembly is formed of a first membrane electrode assembly zone 3a and a second membrane electrode assembly zone 3b that are fixed together in a coplanar and juxtaposing manner. Each membrane electrode assembly zone 3a, 3b has an anode side and a cathode side. The anode collector plate is formed of a first anode collector plate 4a and a second anode collector plate 4b that are fixed together in a coplanar and juxtaposing manner.

The flow field plate is formed of a first flow field plate 5a and a second flow field plate 5b that are fixed together in a juxtaposing manner. The first flow field plate 5a has three side walls 51a, 52a, 53a delimiting a triangular fuel transporting channel 54a. The first flow field plate 5a has a fuel inlet 55a and two fuel outlets 57a, 58a. Similarly, the second flow field plate 5b is formed of three side walls 51b, 52b, 53b delimiting a triangular fuel transporting channel 54b. The second flow field plate 5b has two fuel inlets 55b, 56b and a fuel outlet 57b.

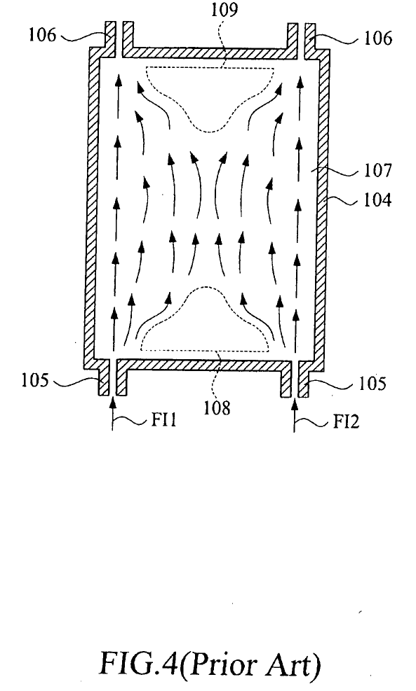

FIG. 12 demonstrates a schematic flow field of the anode side flow field plate of the second embodiment fuel cell, which, as compared to the flow field of the conventional anode side flow field plate shown in FIG. 4, indicates that the fuel transporting channels 54a, 54b of the second embodiment of the present invention are not likely to cause large-area low speed zones 108, 109 occurring in the conventional anode side flow field plates. The fuel transporting channels 54a, 54b of the second embodiment of the present invention demonstrates a substantially uniform distribution of anode fuel wherein the flow speeds at different zones of the flow field are made more uniform as compared to the conventional devices, and this ensures uniform reaction and reducing low speed areas. Thus, as a whole, the flow speed is of a more uniform distribution in the flow field of the flow field plate in accordance with the present invention.

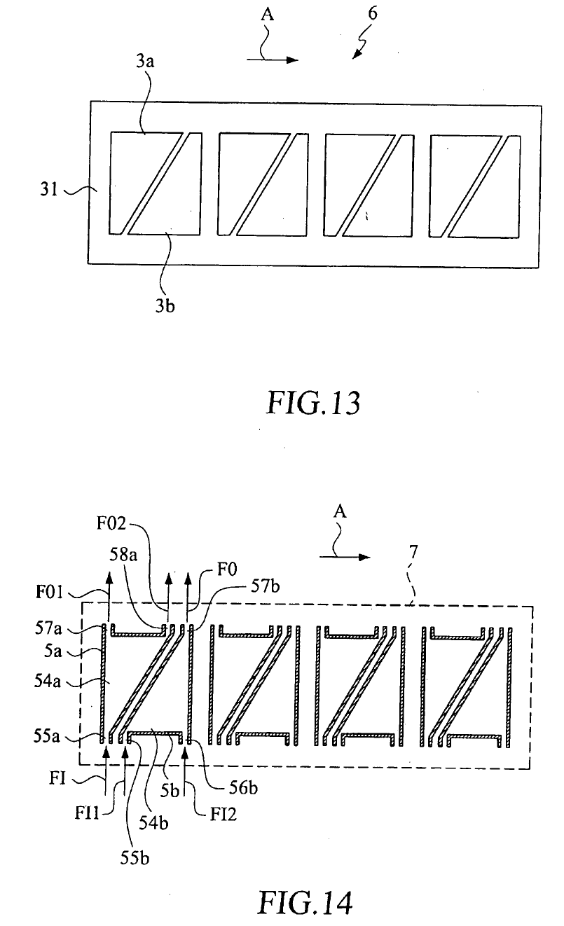

FIG. 13 illustrates a plan view of an integrated or combined membrane electrode assembly constructed in accordance with a third embodiment of the present invention. The combined membrane electrode assembly in accordance with the third embodiment, generally designated at 6, comprises a plurality of paired membrane electrode assembly zones 3a, 3b that are illustrated in FIG. 10, and the plurality of paired membrane electrode assembly zones 3a, 3b are arranged and combined in a row in a direction A to form the combined membrane electrode assembly 6. The combined membrane electrode assembly 6 comprises a frame 31 in which the membrane electrode assembly zone pairs (3a, 3b) are fixed. Each membrane electrode assembly zone pair contains a first membrane electrode assembly zone 3a and a second membrane electrode assembly zone 3b that are fixed together in a juxtaposing manner.

FIG. 14 schematically illustrates a plan view of a combined flow field plate 7 that is used in cooperation with the combined membrane electrode assembly 6 in accordance with the third embodiment of the present invention shown in FIG. 13. In the third embodiment, the combined flow field plate 7 comprises and combines a plurality of paired flow field plates 5a, 5b that are illustrated in FIG. 10. Thus, in the combined flow field plate 7, a plurality of paired flow field plates are included, each of which is formed of a first flow field plate 5a and a second flow field plate 5b fixed together in a juxtaposing manner. The first and second flow field plates 5a, 5b are located exactly corresponding to the first and second membrane electrode assembly zones 3a, 3b illustrated in FIG. 13.

An integrated or combined fuel cell structure may be obtained by stacking the combined membrane electrode assembly 6, the combined flow field plate 7 and the cathode and anode collector plates.

Anode fuel flow FI is fed, through the fuel inlet 55a of the first flow field plate 5a into the fuel transporting channel 54a defined in the flow field plate 5a, and then drained through fuel outlets 57a, 58a as discharged fuel flows FO1, FO2 so as to allow the anode fuel to carry out catalytic reaction with the membrane electrode assembly 3. In addition, anode fuel flows FI1, FI2 are respectively fed through the fuel inlets 55b, 56b of the second flow field plate 5b into the fuel transporting channel 54b of the second flow field plate 5b and then discharged through the fuel outlet 57b as a discharge fuel flow FO.

In a practical assembly, the fuel inlet 55a of the first flow field plate 5a and the fuel inlets 55b, 56b of the second flow field plate 5b may be both in communication with a single fuel supply line for feeding the anode fuel. Further, the fuel outlets 57a, 58a of the first flow field plate 5a and the fuel outlet 57b of the second flow field plate 5b may be both in communication with a single fuel drain line to drain the fuel. This simplifies piping arrangement of the fuel inlet(s) and the fuel outlet(s).

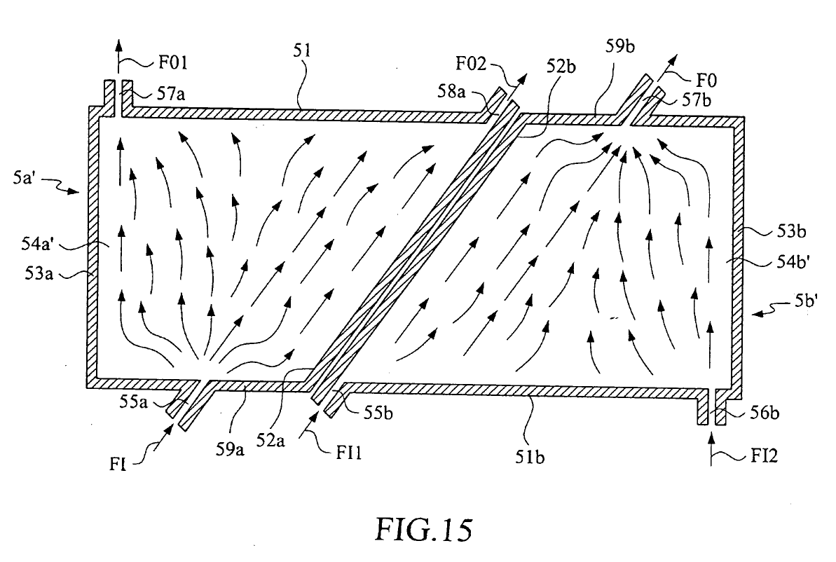

The configuration of the flow field plate as illustrated in FIG. 12 may be modified to a trapezoid configuration to further improve the flow field of the fuel flowing in the fuel transporting channel. As shown in FIG. 15, each of the flow field plates 5a′, 5b′ is modified to have a trapezoid configuration. Namely, the first flow field plate 5a′ has four side walls 51a, 52a, 53a, 59a delimiting a trapezoid fuel transporting channel 54a′. The first flow field plate 5a′ has a fuel inlet 55a and two fuel outlets 57a, 58a. Similarly, the second flow field plate 5b′ is formed of four side walls 51b, 52b, 53b, 59b delimiting a trapezoid fuel transporting channel 54b′. The second flow field plate 5b′ has two fuel inlets 55b, 56b and a fuel outlet 57b. The flow field plates 5a′, 5b′ may be used in a side-by-side combination manner to form a rectangular configuration as shown in FIG. 15. It is to be understood that the flow field plates 5a′, 5b′ may be used separately in practice.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A structure of membrane electrode assembly, comprising:
a frame forming an open space; and
a membrane electrode assembly having an anode side and a cathode side, the membrane electrode assembly being tailored to have three side edges, the three side edges being embedded in the open space of the frame.

2. The structure of membrane electrode assembly as claimed in claim 1, wherein the membrane electrode assembly comprises a proton exchange membrane having an anode side and a cathode side, a surface of the anode side being coated with an anode catalyst layer and an anode gas diffusion layer, a surface of the cathode side being coated with a cathode catalyst layer and a cathode gas diffusion layer.

3. A fuel cell system comprising:
a membrane electrode assembly having a three-edge configuration, the membrane electrode assembly having an anode side and a cathode side;
an anode collector plate arranged at the anode side of the membrane electrode assembly;
a cathode collector plate arranged at the cathode side of the membrane electrode assembly; and
a flow field plate arranged at the anode side of the membrane electrode assembly so as to interpose the anode collector plate between the flow field plate and the membrane electrode assembly, the flow field plate forming a fuel transporting channel that is delimited by three side walls and has three vertices, the configuration of the fuel transporting channel corresponding in shape to the three-edge configuration of the membrane electrode assembly and being in communication with at least one fuel inlet and at least one fuel outlet corresponding to the fuel inlet;
wherein anode fuel is supplied through the fuel inlet of the flow field plate into the fuel transporting channel and then discharged through the fuel outlet whereby the anode fuel carries out catalytic reaction with the membrane electrode assembly.

4. The fuel cell system as claimed in claim 3, wherein the flow field plate comprises a fuel inlet arranged close to one of the three vertices thereof and a fuel outlet arranged close to each of the remaining two vertices.

5. The fuel cell system as claimed in claim 3, wherein the flow field plate comprises a fuel outlet arranged close to one of the three vertices thereof and a fuel inlet arranged close to each of the remaining two vertices.

6. The fuel cell system as claimed in claim 3 further comprising a frame forming an open space in which the membrane electrode assembly is embedded.

7. The fuel cell system as claimed in claim 3, wherein the fuel cell system comprises a direct methanol fuel cell.

8. A fuel cell system, comprising:
at least one membrane electrode assembly comprising first and second membrane electrode assembly zones combined together in a coplanar and juxtaposing manner, the membrane electrode assembly having an anode side and a cathode side;
at least one anode collector plate arranged at the anode side of the membrane electrode assembly;
at least one cathode collector plate arranged at the cathode side of the membrane electrode assembly; and
at least one flow field plate arranged at the anode side of the membrane electrode assembly so as to interpose the anode collector plate between the flow field plate and the membrane electrode assembly, the flow field plate forming first and second fuel transporting channels respectively corresponding to the first and second membrane electrode assembly zones of the membrane electrode assembly, each fuel transporting channel comprising at least one fuel inlet and at least one fuel outlet corresponding to the fuel inlet;
wherein anode fuel is supplied through the fuel inlets of the first and second fuel transporting channels of the flow field plate into the first and second fuel transporting channels respectively and then discharged through the fuel outlets of the first and second fuel transporting channels whereby the anode fuel carries out catalytic reaction with the first and second membrane electrode assembly zones of the membrane electrode assembly respectively.

9. The fuel cell system as claimed in claim 8, wherein the flow field plate comprises a fuel inlet arranged close to one vertex of the flow field plate and a fuel outlet arranged close to each of two other vertices of the flow field plate.

10. The fuel cell system as claimed in claim 8, wherein the flow field plate comprises a fuel outlet arranged close to one vertex of the flow field plate and a fuel inlet arranged close to each of two other vertices of the flow field plate.

11. The fuel cell system as claimed in claim 8 further comprising a frame forming open spaces in which the first and second membrane electrode assembly zones are respectively embedded.

12. The fuel cell system as claimed in claim 8, wherein the fuel cell system comprises a direct methanol fuel cell.
